(19) United States
(12) Patent Application Publication
(10) Pub. No.: US 2004/0263988 A1
(43) Pub. Date: Dec. 30, 2004

(54) Brightness difference ornamental screen with multi-function

(76) Inventor: William Lin, San Jose, CA (US)

Correspondence Address: FORTUNE LAW GROUP, 100 Century Center Ct., San Jose, CA, 95112, US

(21) Appl. No.: 10/601,120

(22) Filed: Jun. 20, 2003

(51) Int. Cl. G02B 27/14

(52) U.S. Cl. 359/630

(57) ABSTRACT

A brightness difference ornamental screen with multi-function includes an ornamental layer, a light display member and a control device for controlling the light display member. The ornamental layer may be set up nearby the light display member. The light display member is connected to the control device. The ornamental layer may be a translucent pattern. The light display member is a light source. There are contents to be displayed behind the ornamental layer. The control device may be a key or a touch switch or an electronic switch to make the light source turn on/off. The ornamental screen has functions as an ornament, as well as displays contents behind the ornamental layer. The ornamental screen has dual-purpose and may utilize space sufficiently, while its structure is simple and purpose is widespread.

### CROSS REFERENCE TO RELATED APPLICATIONS

The present application claims priority under 35 USC 365(a) from PCT/CN00/00731, filed Dec. 26, 2000.

### BACKGROUND OF THE INVENTION

1. Field of the Invention

The present invention relates to an ornamental screen, and more particularly to a multi-function ornamental screen which can display or hide its contents and has multiple functions as an ornamental picture, a mirror, a compound of an ornamental picture and a mirror through which a brightness contrast changes a reflective light or transmissive light.

2. Description of the Related Art

A conventional ornamental screen has a single ornamental function. In some occasions, however, such as were there is a secret map or important information picture, a curtain is often setup in front of the secret map or important information picture to keep the secrets properly. Lift up the curtain when the ornamental screen is in use, and pull on the curtain when the ornamental screen is not in use. However, it can not keep the secrets very well in this manner.

In addition, a television is always put outside in a family room or in a hotel at present, which occupies a great space. If the television i s wanted to inlay a decorative thing (such as a wall, a cupboard), there is not yet a suitable ornamental screen which has functions as an ornament, as well as displays information on the television screen.

U.S. Pat. No. 5,956,181 to William Lin discloses a dual-function mirror which has functions as a rearview mirror and a video display unit. The dual-function mirror works with a camera for the automobile. When a displayer of the mirror is not on, it is a conventional rearview mirror which can observe the rear situations of the automobile conveniently. When the displayer is on, its contents can be displayed as various kinds of needed picture information through the mirror. However, the structure of the dual-function mirror can only make the picture and the mirror convert into each other, which has a limited application.

### SUMMARY OF THE INVENTION

Accordingly, an object of the present invention is to provide a brightness difference ornamental screen with multi-function which functions as an ornament, as well as displays contents behind the ornamental layer and has multiple purposes and utilizes space sufficiently, while its structure is simple and purpose is widespread.

To achieve the above object, a brightness difference ornamental screen with multi-function in accordance with preferred embodiments of the present invention comprises an ornamental layer. The ornamental layer may be set up nearby a light display member. The light display member is connected to a control device for controlling the light display member.

The ornamental layer may be a translucent pattern. The light display member is a light source. There are contents to be displayed behind the ornamental layer. The control device is a key or a touch switch or an electronic switch to make the light source turn on/off.

The light display member may be set up in an ornamental screen and may be a display screen of a computer, an electronic device or a television. The ornamental layer may be a translucent ornamental picture.

The ornamental layer may be a translucent pattern made by laser craft, or a metallization membrane or plated membrane or polishing or texturing or printing methods.

A plurality of display members may be set up in the ornamental layer.

The ornamental layer may be a reflective mirror or a pattern added to a partial mirror or a compound of a pattern and a mirror.

The light display member may be a display screen of a Beep-Pager or a cellular phone, or a palmtop computer or an electronic dictionary or an instant translator or a computer.

A transparent plate or bracket for protecting the inside contents may be set up nearby the ornamental layer.

A case may be provided outside the ornamental layer and a display screen, a lens and a reflective mirror may be installed nearby the display screen. The ornamental layer may be set up on the case. A light display member has light display contents and may be set up nearby the translucent ornamental layer. The light or dark of the light display member may be controlled by an outside switch. The display contents are inserted in or taken out from an opening of the case.

The translucent ornamental layer may be a single layer integral structure made from translucent materials or a compound layer structure made of transparent mirror stuck to a translucent membrane. The light display member nearby the semi-transparent ornamental layer may be a light source or a light source and added lens or an electronic displayer having functions of light and display.

The translucent ornamental layer may be an integral ornamental layer wholly enclosed in the case and installed at an opening or a partial ornamental layer enclosed in the case and installed at the opening.

Size scales showing the volume and position of the reflective objects are marked on the translucent ornament layer or displayed on an electronic display screen.

A display piece or display screen having information display contents may be set up in front of or backside of a light direction of the light source.

The ornamental screen of the present invention has characters of partly reflective light or interdictive light, thus it may have functions of decorating, keeping secrets and the like, and may have transmissive functions which display inside information contents through the ornamental screen while its light source or electronic displayer is on. The ornamental screen of the present invention can accomplish a plurality of functions and has multiple purposes. The ornamental screen of the present invention can put a television into a wall in a family room, hotel or hospital, and the like, and has functions as an ornament and displays information on the television display screen at a front of the television. The ornamental screen of the present invention can save a lot of occupations and beautify the environments. When the television is off, the ornamental screen looks like a picture or a mirror. When the television is on, pictures are displayed on the ornamental screen. When the ornamental screen of the present invention is used as a ornamental screen of a Beep-Pager or cellular phone or palmtop computer, instant translator or notebook, it can especially meet a women's dressing demand, who needn't hand-carry a dressing mirror; An ornamental mirror installed in a sunshading board in an automobile has multiple purposes of a dressing mirror and an electronic displayer. The ornamental screen of the present invention can attain a complete design, e.g., buttons and patterns are distributed on the ornamental screen. When the ornamental screen works, only the inside parts having patterns display it's inside contents for the light, while the other parts are not changed yet, which make its appearance beautiful. The ornamental screen of the present invention has simple structures, convenient utility and widespread purposes.

Other objects, advantages and novel features of the present invention will be drawn from the following detailed descriptions of preferred embodiments of the present invention with the attached drawings, in which:

### BRIEF DESCRIPTION OF THE DRAWINGS

FIG. 1 is a perspective view showing a general structure of a brightness difference ornamental screen with multi-function in accordance with the present invention;

FIG. 2 is a front view of a brightness difference ornamental screen with multi-function in accordance with a first preferred embodiment of the present invention;

FIG. 3 is a side sectional view of the brightness difference ornamental screen with multi-function of FIG. 2;

FIG. 4 is a side view of a brightness difference ornamental screen with multi-function in accordance with a second preferred embodiment of the present invention;

FIG. 5 is a front view of a brightness difference ornamental screen with multi-function in accordance with a third preferred embodiment of the present invention;

FIG. 6 is a front view of a brightness difference ornamental screen with multi-function in accordance with a fourth preferred embodiment of the present invention;

FIG. 7 is a side view of the brightness difference ornamental screen with multi-function of FIG. 6;

FIG. 8 is a perspective view of a brightness difference ornamental screen with multi-function in accordance with a fifth preferred embodiment of the present invention;

FIG. 9 is a perspective view of a brightness difference ornamental screen with multi-function in accordance with a sixth preferred embodiment of the present invention;

FIG. 10 is a side sectional view of a brightness difference ornamental screen with multi-function in accordance with a seventh preferred embodiment of the present invention;

FIG. 11 is a side sectional view of a brightness difference ornamental screen with multi-function in accordance with a eighth preferred embodiment of the present invention;

FIG. 12 is a side sectional view of a brightness difference ornamental screen with multi-function in accordance with a ninth preferred embodiment of the present invention;

FIG. 13 is a perspective view of a brightness difference ornamental screen with multi-function in accordance with a tenth preferred embodiment of the present invention;

FIG. 14 is a perspective view of a brightness difference ornamental screen with multi-function in accordance with a eleventh preferred embodiment of the present invention; and

FIG. 15 is a side sectional view of a brightness difference ornamental screen with multi-function in accordance with a twelfth preferred embodiment of the present invention.

### DESCRIPTION OF THE PREFERRED EMBODIMENT

Structures and work principles of a brightness difference ornamental screen with multi-function of the present invention will be described in its preferred embodiments.

Referring to FIG. 1, a brightness difference ornamental screen with multi-function in accordance with the present invention comprises an ornamental layer 1, a light display member 2 and a control device 3 for controlling the light display member. The control device 3 may be connected to the light display member 2. The ornamental layer 1 may be provided nearby the light display member 2. The ornamental layer 1 can hide or display images or contents in the ornamental screen depending on light situations of the light display member 2 through transmitted lights, reflected lights or interdicted lights.

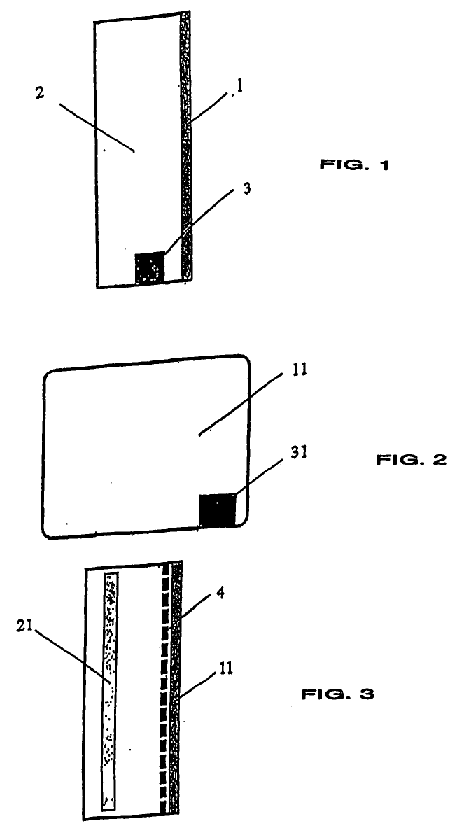

FIGS. 2 and 3 show a first preferred embodiment of the present invention. The ornamental layer may be a translucent ornamental pattern 11 like a picture made by laser technology (Prior Art, not stated again). The light display member is a light source 21. Contents to be displayed 4 are set up behind the ornamental pattern 11. The contents 4 can be maps or drawings needed to be kept secret, or the like. The control device 31 may be a special controller to make the light source 21 turn light or opaque. When the ornamental screen is used in a secret occasion, the inside contents 4, such as secret maps or important information pictures, can't be seen because of a reflective light character of a surface of the ornamental pattern 11. While the light display member or the other light source is turned on, contents 4 to be displayed can be clearly seen by utilizing a transmissive light character of the ornamental pattern 11.

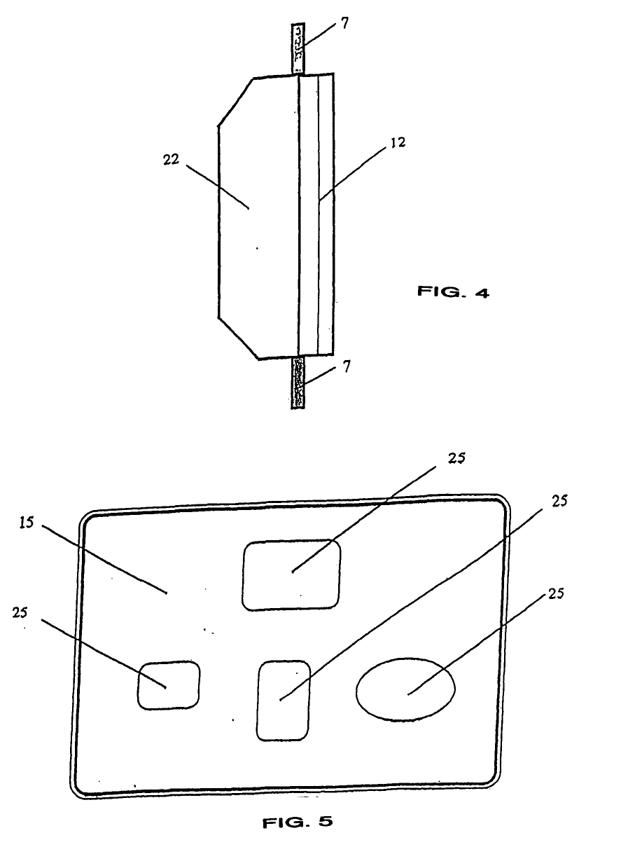

FIG. 4 shows a second preferred embodiment of the present invention. The light display member provided in a wall 7 may be a display screen 22 of a computer, an electronic device or a television. The ornamental layer is a translucent ornamental picture 12. The control device for the light display member is a display screen switch of a computer, an electronic device or a television. When the switch is off, an ordinary ornamental picture, a mirror or a compound pattern of the ornamental picture and the mirror appears in front of the display screen. A picture or a mirror can be seen, while the contents behind the ornamental layer are not seen clearly. When the switch is on, pictures in the computer, or electronic device or television can be displayed clearly on the ornamental layer nearby the display screen. The ornamental screen can be widely applied in public places such as an advertisement field for advertisements, a bank for payment, a supermarket place for information inquiry, or other places for beautification or decoration, and the like. It also can be used in a medical institution for guardianship, test equipment, axenic sanitation, or in a house, hotel or restaurant, which not only produces a beautiful view, but also greatly saves occupations. Especially when it is used outdoors, the ornamental screen provides a protection function such as seal of dustproof, waterproof and shielding the sunshine and an ornament function. At the same time it does not influence on the normal image display functions.

The ornamental layer of the present invention can be a surface-managed film, a special film, or a pattern made by laser craft, or a metallized membrane, plated membrane having half reflective light and half transmissive light characters made by such ways as polishing, texturing, printing, or the like, or a translucent anti-counterfeit mark or an ornamental membrane made by controlling the manufacture craft as requirement to obtain the needed light reflectivity and transmissive light ratio, or the like. The not-good transparent materials or transparent materials mixed with impurities having reflective light and transmissive light functions are also a suitable selection, for example a medium mirror made of smoke color glass.

FIG. 5 shows an ornamental screen in accordance with a third preferred embodiment of the present invention. A plurality of light display members 25 having different shapes or different types may be installed in an ornamental layer 15. The ornamental screen can be used in many occasions.

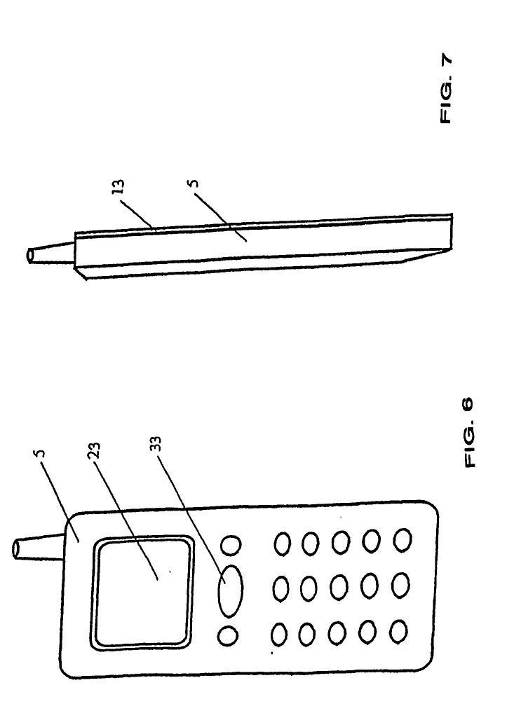

FIGS. 6 and 7 show a fourth preferred embodiment of the present invention. The ornamental layer may be a reflective mirror or a pattern added to a partial mirror or a compound of a pattern and a mirror 13. The light display member may be a display screen 23 of a Beep-Pager, a cellular phone 5, a palmtop computer, an electronic dictionary, an instant translator or a computer. The control device for the light display member may be a display screen switch 33 of the Beep-Pager, cellular phone 5, palmtop computer, electronic dictionary, instant translator or computer. When the display screen switch is off, the ornamental layer is a reflective mirror, which can be used as a dressing mirror by a user, especially by a woman. When the display screen switch is on, the ornamental layer has a transmissive light character, which can clearly display the contents in the Beep-Pager, cellular phone or palmtop computer, thus the ornamental screen has many increased functions.

A translucent membrane having a reflective light and transmissive light character may be plated or glued on a surface of the reflective mirror 13, which can be manufactured in the following ways. An original reflective light membrane of the mirror may be changed into a semi-transmissive light membrane. An original surface of the main body (such as glass, transparent plastics or ordinary materials having needed reflective light surface) of the mirror may be plated with a thin membrane (such as aluminum membrane, silver membrane) having a reflective light and transmissive light character, or a thin film made from materials having reflective light and transmissive light character glued a film having a reflective light and transmissive light character. The surface of the mirror can also be materials which are not good transparent or transparent materials mixed some impurities, which make the ornamental screen have functions of reflective light and transmissive light (such as medium mirror made from smoke color or the like).

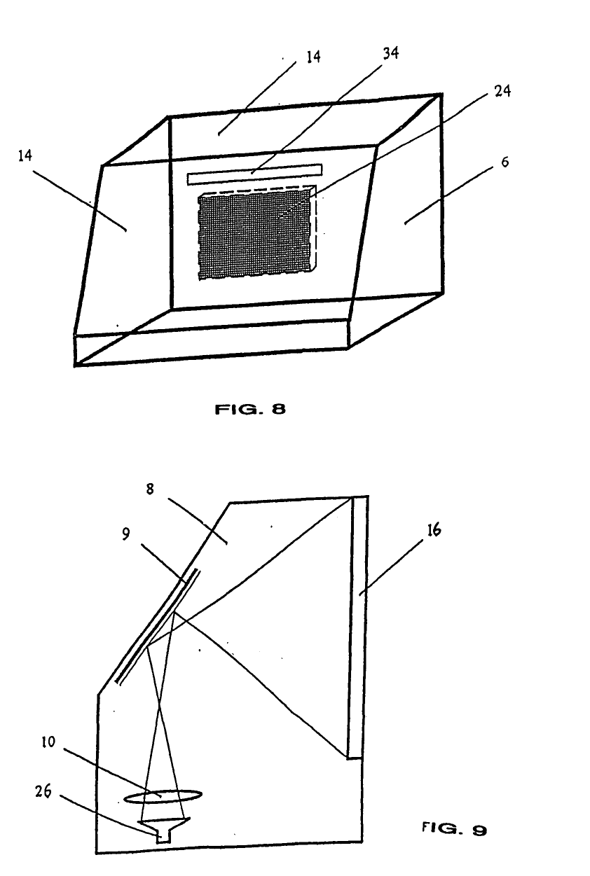

FIG. 8 shows a fifth preferred embodiment of the present invention. A transmissive plate or bracket 6 for protecting inside contents 24 may be installed in an ornamental layer 14. When brightness of a light source 34 is dark, the transmissive plate 6 with an ornamental layer shows a reflective light or an interdictive light character. When the light source 34 is bright, the transmissive plate 6 shows a transmissive light character, for example exhibition platform in the museum or exhibition cupboard in a marketplace.

FIG. 9 shows a sixth preferred embodiment of the present invention. An ornamental layer 16 and a display screen 26 are installed in a case 8. A lens 10 and a reflective mirror 9 are installed nearby the display screen 26. For example, screens of a rear-projection type cinema or a rear-projection type large-screen television, are no longer a single white or dark color and usually are a beautiful picture, which can beautify the environments. The display member can transmit images through the ornamental layer as a screen.

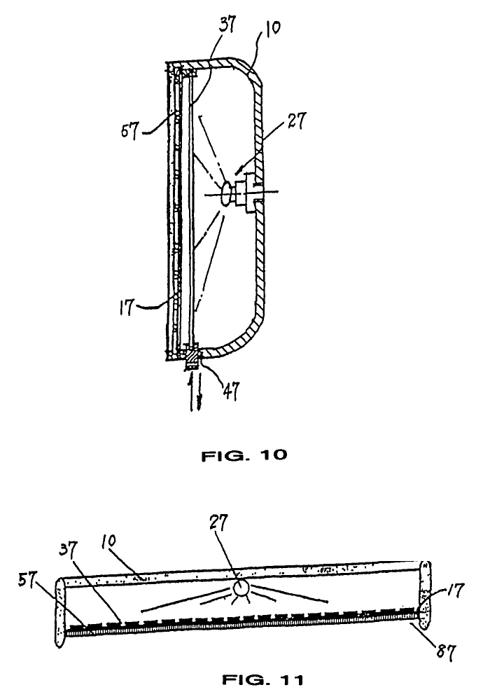

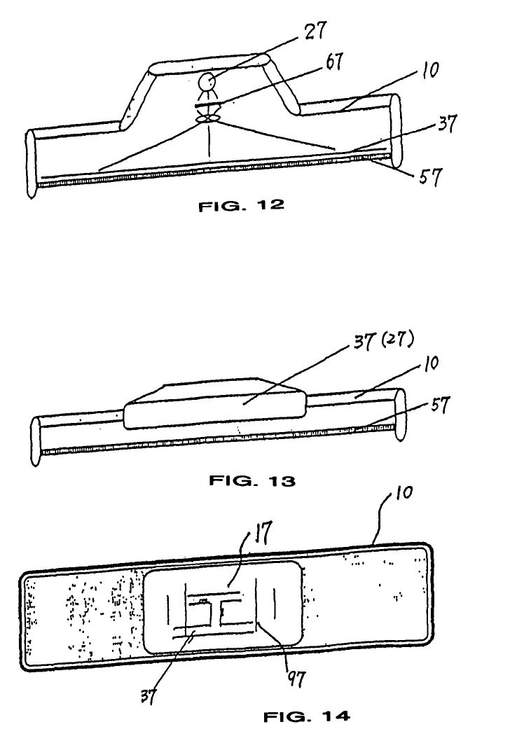

FIGS. 10, 11, 12, 13, 14 and 15 respectively show seventh, eighth, ninth, tenth, eleventh and twelfth preferred embodiments of the present invention. An ornamental layer 17 may be installed in a case 10. The ornamental layer 17 may be translucent. A light display member 27 having display contents 37 may be installed nearby the ornamental layer 17. Brightness or darkness of the light display member 27 may be controlled by an outside switch. The display contents 37 are inserted in or taken out from an opening 47 of the case 10. Referring to FIGS. 11 and 12, the display piece or display screen can be inserted or changed from the opening 47 of the case 10. The display piece or display may be generally made of a transparent or translucent film or membrane.

The semi-transparent ornamental layer 17 may be a single layer integral structure made from translucent materials or a compound layer structure made of a transparent mirror 57 and a translucent membrane stuck to the transparent mirror 57. Referring to FIGS. 11 to 14, the light display member nearby the translucent ornamental layers 17 may be a light source or a light source added a lens 67 or an electronic displayer having functions of light and display.

Referring to FIGS. 11 and 12, a display piece or display screen 77 having information display contents may be provided in the case 10 installed between the light source and the translucent ornamental layer.

Referring to FIGS. 10 to 14, the translucent ornamental layer 17 fully enclosed in the case 10 may be an integral ornamental layer installed at an opening 87 or the translucent ornamental layer 17 enclosed in the case 10 may be a partial ornamental layer installed at the opening 87.

Referring to FIG. 14, size scales 97 are marked on the translucent ornamental layer showing a volume and position of a reflective object.

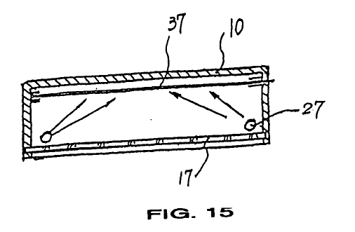

Referring to FIG. 11 or 15, the display piece or display screen having information display contents may be installed nearby a light direction of the light source.

The present invention can also be used in an automobile rearview mirror. The followings are detailed descriptions. A rear view mirror only having rear view function is changed into a dual-function mirror as a rear view mirror and a video displayer. Information such as maps, way maps, or the like or an electronic displayer can be freely put in the mirror. Usually when there is no light in the mirror, the mirror is an ordinary rear view mirror. When there is light in the mirror, information in the mirror is can be seen. Making the inside mirror light or not can change the functions of the rear view mirror.

The automobile rear view mirror has benefits.

First, the driver can attain more information (such as maps, time tables, way maps, suggestive information put in advance and pictures shown on an electronic displayer from a video camera, and scenes behind the automobile, and the like) from the rear view mirror without his habits changed and his attention dispersed.

Second, the installation position and basic structure of the transmissive and reflective light rear view mirror is just a replacement of the original ordinary rear view mirror's, thus it will not cause the driver and passengers to have burdensome senses and insecurity senses for the increased new things in automobile.

Third, the switch is controlled artificially. The driver can choose to use it as a transmissive and reflective light mirror seeing the inside information or as an ordinary rear view mirror at any time in necessary.

Fourth, the light area inside the mirror can be changed to make the mirror into a whole transmissive and reflective light mirror or a partial transmissive and reflective light mirror (see FIG. 14).

Fifth, the reflective way which the light source is put in front of the display screen (see FIG. 15) can be attained.

This transmissive and reflective light mirror has three work states, ordinary reflective light rear view mirror, reflective light added pictures, and all the display pictures. When the transmissive and reflective light mirror works as an electronic rear view mirror made from electronic displayer, scales showing the width and height of an automobile are marked on the opposite area of the display medium mirror, thus to benefit the driver judging the relative position of the automobile and the other outside objects (see FIG. 14).

This rear view mirror can be made into several structure forms, direct light and picture way, see FIG. 11, projective picture way, see FIG. 12, electronic display way, see FIG. 13.

An electronic display screen can also be put in a dressing mirror of a sunshading board of the automobile, the original mirror may be changed into the translucent and half reflective light ornamental screen of the present invention, which it is still a dressing mirror in normal, and the display contents can be seen when the electronic display screen works.

While the present invention has been illustrated by the descriptions of the preferred embodiments thereof, and while the embodiments has been described in considerable detail, it is not intended to restrict or in any way limit the scope of the appended claims to such detail. Additional advantages and modifications within the spirit and scope of the present invention will readily appear to those skilled in the art. Therefore, the present invention is not limited to the specific details and illustrative example shown and described.

What is claimed is:

1. A brightness difference ornamental screen with multi-function comprising:
an ornamental layer;
a light display member;
a control device for controlling the light display member; and
wherein the ornament layer may be set up nearby the light display member and the light display member is connected to the control device.

2. The ornamental screen as claimed in claim 1, further comprising contents to be displayed behind the ornamental layer and wherein the ornamental layer comprises a translucent pattern, the light display member comprises a light source, and the control device comprises a key or a touch switch or an electronic switch operable to make the light source turn on/off.

3. The ornamental screen as claimed in claim 1, wherein the light display member may be set up in an ornamental object, the light display member comprises a display screen of a computer, an electronic device or a television, and the ornamental layer comprises a translucent ornamental picture.

4. The ornamental screen as claimed in claim 1, wherein the ornamental layer comprises a translucent pattern made by laser craft, or a metallization membrane or plated membrane made in polishing or texturing or printing ways.

5. The ornamental screen as claimed in claim 1, further comprising a plurality of display members set up nearby the ornamental layer.

6. The ornamental screen as claimed in claim 1, wherein the ornamental layer comprises a reflective mirror or a pattern added to a partial mirror or a compound of a pattern and a mirror.

7. The ornamental screen as claimed in claim 1, wherein the light display member comprises a display screen of a Beep-Pager or a cellular phone, or a palmtop computer or an electronic dictionary or an instant translator or a computer.

8. The ornamental screen as claimed in claim 1, further comprising a transparent plate or bracket for protecting an inside contents disposed adjacent the ornamental layer.

9. The ornamental screen as claimed in claim 1, further comprising a case disposed outside the ornamental layer and a display screen, a lens and a reflective mirror installed nearby the display screen.

10. The ornamental screen as claimed in claim 1, further comprising a case upon which the ornamental layer is set up, the light display member comprising a light display contents which are disposed nearby the ornamental layer, operation of the light display member being controlled by an outside switch, and the display contents being insertable from an opening in the case.

11. The ornamental screen as claimed in claim 1, wherein the translucent ornamental layer comprises a single layer integral structure made from translucent materials or a compound layer structure made from transparent mirror stuck to a translucent membrane, the light display member being disposed nearby the ornamental layer, and the light display member comprising a light source, a light source having a lens, or an electronic display device having functions of light and display.

12. The ornamental screen as claimed in claim 1, wherein the ornamental layer comprises an integral ornamental layer wholly enclosed in a case and installed at an opening in the case or a partial ornamental layer enclosed in the case and installed at the opening.

13. The ornamental screen as claimed in claim 1, wherein size scales showing a volume and a position of reflected objects are marked on the ornamental layer or displayed on an electronic display screen.

14. The ornamental screen as claimed in claim 14, further comprising a display piece or display screen having information display contents installed in front of or backside of a light direction of the light display member.
